(19) United States
(12) Patent Application Publication
(10) Pub. No.: US 2019/0322518 A1
(43) Pub. Date: Oct. 24, 2019

(54) DISPENSING APPARATUS AND METHOD OF USE THEREOF

(71) Applicant: Jonathan Bond, Yorkshire (GB)

(72) Inventor: Jonathan Bond, Yorkshire (GB)

(21) Appl. No.: 16/386,525

(22) Filed: Apr. 17, 2019

(30) Foreign Application Priority Data
Apr. 18, 2018 (GB) 1806302.4

(51) Int. Cl. B67D 1/08; B67D 1/12

(52) U.S. Cl. CPC B67D 1/0882; B67D 1/1277; B67D 1/0857

(57) ABSTRACT

Dispensing apparatus is provided for dispensing one or more items therefrom in use. The apparatus includes at least one reservoir for containment of the one or more items to be dispensed. Dispensing outlet means are provided for dispensing the one or more items from said apparatus. At least one flow conduit or flow line is located between the at least one reservoir and the dispensing outlet means. Valve means are provided with or associated with said dispensing outlet means to control dispensing of the one or more items from said dispensing outlet means in use. The valve means are movable between an open position, wherein the one or more items can be dispensed from the dispensing outlet means, and a closed position, wherein the one or more items are prevented from being dispensed from said dispensing outlet means. The apparatus includes multiple dispensing outlet means, and a control unit is provided and is arranged to communicate with and/or control at least two, or all, of said multiple dispensing outlet means.

This invention relates to dispensing apparatus and to a method of use thereof.

Although the following description refers almost exclusively to dispensing apparatus for dispensing a beverage such as beer therefrom, it will be appreciated by persons skilled in the art that the dispensing apparatus of the present invention could be used to dispense any flowable component in use therefrom, such as a powder, grain, granular material, any liquid and/or the like.

Conventional apparatus for dispensing beer in a bar typically comprises a beer keg located remotely from the bar, such as in a cellar, a beer dispensing tap located in the bar for dispensing beer into appropriate glassware, and a beer line or conduit located between the beer keg and the beer tap. A cooling device may be provided in the beer line or conduit to allow the beer to be cooled during passage of the beer from the keg to the tap.

In one known example of beer dispensing apparatus, a calibrated metering pump can be provided which allows a pre-determined measured volume of beer to be dispensed via the beer dispensing tap in use per actuation of the tap. This type of system is known as a metered line system. Problems associated with this type of system is the metering pumps are expensive to provide and they do not allow for a beverage to be “topped up” in the event of spillage or as a result of a beer head being formed during dispensing that spills over the top of the glassware being filled.

In an alternative known example of beer dispensing apparatus, the user manually controls the volume of beer being dispensed from the beer dispensing tap. This type of system is known as a free flow line system and overcomes the abovementioned problems. However, a problem with this type of system is that when the keg becomes empty and requires changing, if the dispensing tap is left open, the system becomes depressurised and the beer line fills up with gas and beer foam, known as fobbing. A fob detector is typically provided in association with the keg. An example of a conventional fob detector is a mechanical device that is located at the keg to prevent gas from entering the product line from the keg end of the system when the keg becomes empty. The fob detector includes a float or ball that sits above the keg in a chamber. With the keg full of beer, the float sits at the top of the chamber and beer is able to flow out of a side outlet, along the beer line and through to the dispensing tap.

As the keg becomes empty, the float level drops as the beer is replaced with gas in the chamber. When the float reaches the bottom of the chamber it closes the side outlet to prevent excess fob from entering the beer line. Once a bar worker realises the beer keg is empty, they have to physically go where the empty keg is located, connect a new keg to the beer line, drain off any excess fob/gas in the beer line and re-pressurise the beer line. This is time consuming for the bar worker, particularly if the beer line is relatively long. In addition, despite a fob detector being present, depressurisation of the beer line still takes place due to the dispensing tap being open for a period of time prior to the bar worker realising the keg is empty. As such, there is still a requirement for draining of the beer line of excess fob/gas which can cause significant beer wastage. This can result in a significant loss of earnings for the bar.

GB2404651 discloses a beverage dispense system wherein a single dispense tap is provided remote from a liquid source. A flow line is provided between the liquid source and the dispense tap. A control valve is positioned at or adjacent the dispense tap to control the flow of liquid to the tap. Means are provided for detecting when the liquid source contains insufficient liquid for dispensing and closes the control valve to maintain liquid in the flow line. The above system is only for a single dispense tap and the system therefore has limited use only. Communication between the components of the system is via wired means and therefore setting up of the system is time consuming and requires adaptations to the building in which the system is located to allow accommodation of the wired system. The system does not allow a user to determine that the liquid source has run out or is off in different locations and does not allow a user to easily determine liquid volume consumption.

It is therefore an aim of the present invention to provide dispensing apparatus that overcomes the abovementioned problems.

It is a further aim of the present invention to provide a beverage dispensing apparatus that overcomes the abovementioned problems.

It is a yet further aim of the present invention to provide a method of using dispensing apparatus.

It is a yet further aim of the present invention to provide a method of using beverage dispensing apparatus.

It is an aim of the present invention to provide dispensing outlet means that overcomes the abovementioned problems.

It is an aim of the present invention to provide a method of using dispensing outlet means that overcomes the abovementioned problems.

According to a first aspect of the present invention there is provided dispensing apparatus for dispensing one or more items therefrom in use, said apparatus including at least one reservoir for containment of the one or more items to be dispensed, dispensing outlet means for dispensing the one or more items from said apparatus, and at least one flow conduit or flow line located between the at least one reservoir and the dispensing outlet means, and wherein valve means are provided with or associated with said dispensing outlet means to control dispensing of the one or more items from said dispensing outlet means in use, said valve means movable between an open position, wherein the one or more items can be dispensed from said dispensing outlet means, and a closed positions, wherein the one or more items are prevented from being dispensed from said dispensing outlet means, characterised in that the apparatus includes multiple dispensing outlet means, and a control unit is provided and is arranged to communicate with and/or control at least two, or all, of said multiple dispensing outlet means.

Thus, the present invention has the advantage that a single control unit can control multiple dispensing outlet means, thereby allowing the apparatus to be scaled up and/or down quickly, easily and without significant cost. Additional dispensing outlet means can be added to or removed from the apparatus as and when required without significant duplication or removal of components respectively. The control unit can be arranged to control at least two, or all, the dispensing outlet means simultaneously and/or to control each dispensing outlet means independently of one or more other dispensing outlet means forming the apparatus.

Preferably individual valve means are provided on or associated with each of the dispensing outlet means.

Preferably the control unit controls and/or communicates with the dispensing outlet means via the valve means provided on or associated with the, or each, dispensing outlet means and/or via a central valve control unit that communicates with all the valve means.

Preferably the apparatus includes detection means or a detection device which is any device for detecting when the reservoir contains an insufficiency or none of said items to be dispensed therefrom.

Further preferably following said detection, said apparatus is arranged to move said valve means associated with one or more, or all of the dispensing outlet means from the open position to said closed position.

Preferably the detection means communicates with the control unit and, on detection of insufficient or no items to be dispensed from the reservoir, the control unit signals to the valve means to move the same from the open position to the closed position.

The advantage of this is that the valve means provided with or associated with the dispensing outlet means can be moved to a closed position as soon as the detection means detects the reservoir is empty or detects there is insufficient or no items to be dispensed, thereby preventing depressurisation of the system. In beverage dispensing apparatus, this can prevent the formation of fob within the apparatus in a simple and effective manner, thereby saving on beverage wastage and associated loss of earnings.

In one embodiment the control unit is arranged to control and/or communicate with the valve means and/or the detection means in use.

In one embodiment the control unit communications with the dispensing outlet means, the valve means and/or the detection means via wired and/or wireless means or methods. In one example, the control unit is arranged to communicate via both or either of the wired means and the wireless means and, depending on the setting in which the apparatus is located, a user is able to select the preferred form or forms of communication used via the system. This makes the system very adaptable to a large range of applications. For example, the apparatus can be set up in a permanent setting, such as a bar or pub, using wired and/or wireless means, or can be set up in temporary setting such as a pop up bar where wireless means may be appropriate. The apparatus of the present invention can be used in bars where dispensing outlet means are provided at multiple locations within a setting, such as on different floors of a building, in different rooms or locations within a building and/or the like. A central control unit can be provided to communicate and control two or more, or all, the dispensing outlet means at the different locations.

In one embodiment the wireless means or methods includes or consists of any or any combination of wireless mechanism, WIFI, Bluetooth, one or more radio frequency signals and/or the like. The use of wireless communication is advantageous in that it can be used in “pop-up” bars, in outside bars and/or in any environment where the use of wiring is not possible, it too time consuming to fit, is unsafe to use and/or the like.

In one embodiment the wired means includes any or any combination of one or more wires, cables, conduits, fibres and/or the like.

Preferably the dispensing outlet means, the control unit, the valve means and/or the detection means communicate via one or more data and/or digital signals that are transmitted and/or received from or with the same.

In one embodiment the dispensing outlet means, the control unit, the valve means and/or the detection means includes one or more transmitter means or device, receiving means or device and/or transceiver means or device for transmitting and/or receiving one or more data and/or digital signals in use.

Preferably the control unit is located remotely from the valve means, the dispensing outlet means, the at least one reservoir and/or the detection means.

Preferably the control unit includes micro-processing means or a micro-processor for processing one or more data and/or digital signals being received and/or transmitted therefrom.

Preferably the control unit includes memory means or device or a data storage device for storing data thereon in use.

Preferably the data to be stored can include software, collected data, one or more reports and/or the like.

Preferably the control unit includes user actuation means or member to allow a user to actuate one or more functions of the dispensing apparatus and/or control unit in use.

Preferably the user actuation means or member includes one or more buttons, switches, dials, joystick, keys, touch screen and/or the like.

Preferably display means or a display is provided on or associated with the control unit for displaying one or more data items and/or functions in use.

In one embodiment the detection means includes any means, device or mechanism which can detect the at least one reservoir is empty and/or there is an insufficiency or none of said one or more items to be dispensed from said at least one reservoir in use. For example, the detection means could include weight detection means which can detect a change in weight of the one or more reservoirs, sonic level detection means, ultrasonic level detection means, fob detection means, pressure detection means that can detect a change in pressure and/or the like.

Preferably the fob detection means is an electronic fob detection means and/or an electronic metered fob detection means.

Preferably the detection means includes at least one reed switch that is actuated when the at least one reservoir becomes empty and/or insufficient items are available in the at least one reservoir for dispensing.

Preferably the at least one reed switch is a continuity switch that sends a data and/or power signal to the control unit. This in turn preferably moves the valve means from the open position to the closed position in one example.

Preferably the detection means is provided on or associated with the at least one reservoir.

In one embodiment the valve means is any type of valve arrangement or valve member that can be moved between open and closed positions automatically and/or remotely.

Preferably the valve means is movable between the open and closed positions independently of actuation of the dispensing outlet means.

In one embodiment the valve means is electronically controlled.

In one embodiment the valve means is in the form of one or more solenoid valves.

Preferably the valve means is normally in an open position in use.

Preferably the valve means is moved to a closed position upon detection by the detection means of insufficient items to be dispensed from the reservoir.

Preferably the valve means requires no power or a reduced power supply to maintain the valve means in an open position in use, thereby ensuring the apparatus requires no or minimal power supply to operate the same in use.

In one embodiment the valve means is a free flow type in that it allows any, a manually controlled and/or an arbitrary volume or quantity of the one or more items to pass through the same in use when the valve means is in an open position.

In one embodiment the valve means is a metered flow type in that it controls the volume, amount and/or quantity of one or more items being dispensed therefrom in use.

In one embodiment the dispensing outlet means is any device that allows one or more items to flow from or through an outlet aperture in use, when in an open position in use, to allow dispensing of said items through said outlet aperture.

In one embodiment the dispensing outlet means is a manually actuated dispensing outlet means. In this example, preferably a user is able to manually control the volume or amount of the one or more items being dispensed therefrom in use.

In one embodiment the dispensing outlet means is an electronically actuated dispensing means.

Preferably the dispensing outlet means includes or consists of a tap, font dispenser and/or the like.

Preferably the apparatus includes two or more dispensing outlet means per reservoir used in the apparatus.

Yet further preferably the apparatus includes three or more dispensing outlet means per reservoir used in the apparatus, and preferably four or more dispensing outlet means per reservoir used in the apparatus.

In one embodiment the dispensing outlet means can be moved between a closed position, wherein dispensing of one or more items therefrom is prevented, and an open position, wherein one or more items can be dispensed therefrom in use.

Preferably both the dispense outlet means and the valve means need to be in an open position before one or more items can be dispensed from the dispense outlet means in use.

In one embodiment the valve means are connected to the dispensing outlet means and/or are provided upstream of the dispensing outlet means (i.e. between the dispensing outlet means and the at least one reservoir).

In one embodiment the valve means are provided in, are integral with and/or form part of the dispensing outlet means.

Thus, in one example, the dispensing outlet means includes a solenoid valve provided therein.

Preferably the one or more items for dispensing can include any or any combination of one or more beverages, grain, powder, granular material, liquid, beer, larger, spirits, wine and/or the like.

In one embodiment the apparatus includes power supply means or a power supply for providing electrical power to the control unit, the dispensing outlet means, the valve means, the detection means and/or the like.

The power supply means can include any power supply, mains power supply, a generator, one or more batteries, rechargeable batteries, solar power, wind generated power and/or the like.

Preferably the power supply provides a 24V power supply.

In one embodiment the apparatus includes indication means or an indication device to allow the status of the dispensing outlet means, the valve means, the flow conduit and/or flow line and/or the detection means to be indicated to a user in use.

Preferably the indication means includes any or any combination of visual indication means or device, audio indication means or device, or kinaesthetic indication means or device.

In one embodiment the visual indication means or device can include one or more lights, light emitting means, data signs and/or the like. For example, one or more lights could be illuminated when the valve means is in a closed position, when the detection means has detected there is insufficient items to be dispensed from the reservoir and/or the like.

In one embodiment the audio indication means or device include one or more alarms, sounds and/or the like.

In one embodiment the kinaesthetic indication means or device include one or more vibration means and/or the like.

Preferably the indication means are provided on, associated with, or in the locality or vicinity of the dispensing outlet means.

In one embodiment temperature control means or mechanism are provided in or associated with the apparatus for controlling a temperature of one or more parts of the apparatus in use.

Preferably the temperature control means includes one or more heaters or heating devices for heating one or more parts of the apparatus in use.

Preferably the temperature control means includes one or more cooling devices for cooling one or more parts of the apparatus in use.

Preferably the temperature control means, the one or more heating and/or cooling devices are provided one or associated with the at least one flow conduit or flow line in use.

In one embodiment the one or more reservoirs includes one or more containers, kegs, barrels, bottles, drums and/or the like.

In one embodiment where the dispensing apparatus is a beverage dispensing apparatus, preferably the one or more flow conduits and/or flow lines are in the form of one or more free flow lines or unmetered flow lines.

In one embodiment the control unit and/or valve means can have valve control means associated with the same. Preferably this allows a user to control the valve means irrespective of or independently of the status of the detection means. For example, if a user requires cleaning of one or more parts of the dispensing apparatus, the user can move the valve means from the open position to the closed position during the cleaning process. Once the cleaning process has been completed, the user can move the valve means from the closed position to the open position.

In one embodiment the control unit can control the dispensing outlet means directly. For example, this can be used to prevent the dispense outlet means being left in an open position when the valve means is being moved from a closed position to an open position following the changing of a reservoir and/or the like.

In one embodiment one or more parts of the dispensing apparatus of the present invention can be retrofitted to existing dispensing apparatus.

In one embodiment the detection means communicates via the control unit to control the valve means and move the same between the open and closed positions in use.

In one embodiment the detection means can communicate directly with the valve means to move the same between the open and closed positions in use.

In one embodiment once the valve means has been moved from the open position to the closed position as a result of one or more signals being transmitted from the detection means about the status of the at least one reservoir, the valve means remains in a closed position until the at least one reservoir has been changed and/or refilled such that the detection means detects there is sufficiency of the one or more items to be dispensed therefrom.

Preferably the valve means is arranged downstream from the detection means.

Preferably the valve means is arranged upstream of the dispensing outlet means.

Preferably each of the multiple dispensing outlet means can be used independently of each other.

According to a second aspect of the present invention there is provided a method of using dispensing apparatus for dispensing one or more items therefrom in use, said apparatus including at least one reservoir for containment of the one or more items to be dispensed, dispensing outlet means for dispensing the one or more items from said apparatus, and at least one flow conduit or flow line located between the at least one reservoir and the dispensing outlet means, and wherein valve means are provided with or associated with said dispensing outlet means to control dispensing of the one or more items from said dispensing outlet means in use, said valve means movable between an open position, wherein the one or more items can be dispensed from the dispensing outlet means, and a closed position, wherein the one or more items are prevented from being dispensed from said dispensing outlet means, said method including the steps of dispensing the one or more items from the apparatus via moving the valve means from the closed position to the open position, moving the dispensing outlet means from a closed position to an open position, moving the items from the at least one reservoir to the dispensing outlet means via the at least one flow conduit or flow line, and characterised in that the apparatus includes multiple dispensing outlet means, and a control unit is provided and is arranged to communicate with and/or control at least two, or all, of said multiple dispensing outlet means.

According to further independent aspects of the present invention there is provided beverage dispensing apparatus; and a method of using beverage dispensing apparatus.

According to one independent aspect of the present invention there is provided dispensing apparatus wherein indication means are provided for indicating the status or operational status of the at least one reservoir, the dispensing outlet means, the valve means and/or the detection means in use.

Preferably the indication means are provided on, associated with or in the locality or vicinity of the dispensing outlet means.

Preferably the indication means include any or any combination of visual, audio and/or kinaesthetic indication means.

According to one independent aspect of the present invention there is provided dispensing apparatus wherein the detection means includes one or more sonic flow detection devices or ultrasonic flow detection devices.

According to one independent aspect of the present invention there is provided dispensing outlet means for dispensing one or more items therefrom in use, and wherein said dispensing outlet means includes valve means for controlling the flow of the one or more items from said dispensing outlet means in use, said valve means movable between an open position, wherein the one or more items can be dispensed from said dispensing outlet means, and a closed positions, wherein the one or more items are prevented from being dispensed from said dispensing outlet means, and wherein said dispensing outlet means are arranged such that the valve means can be controlled to move between the open and closed positions via a remote control unit and/or following detection of one or more pre-determined conditions.

Preferably the valve means is a solenoid valve.

Preferably the one or more pre-determined conditions is the detection of a reservoir connected to or associated with the dispensing outlet means being empty or containing insufficient items to dispense.

Preferably the dispensing outlet means is in the form of a font dispenser, beer tap and/or the like.

Preferably the dispensing outlet means has an outlet aperture for dispensing one or more items therefrom.

Preferably the dispensing inlet means has an inlet aperture for allowing one or more items to enter the dispensing outlet means in use.

It will be appreciated that any or any combination of the abovementioned embodiments could be provided in the dispensing apparatus of the present application.

Embodiments of the present invention will now be described with reference to the following figures, wherein:

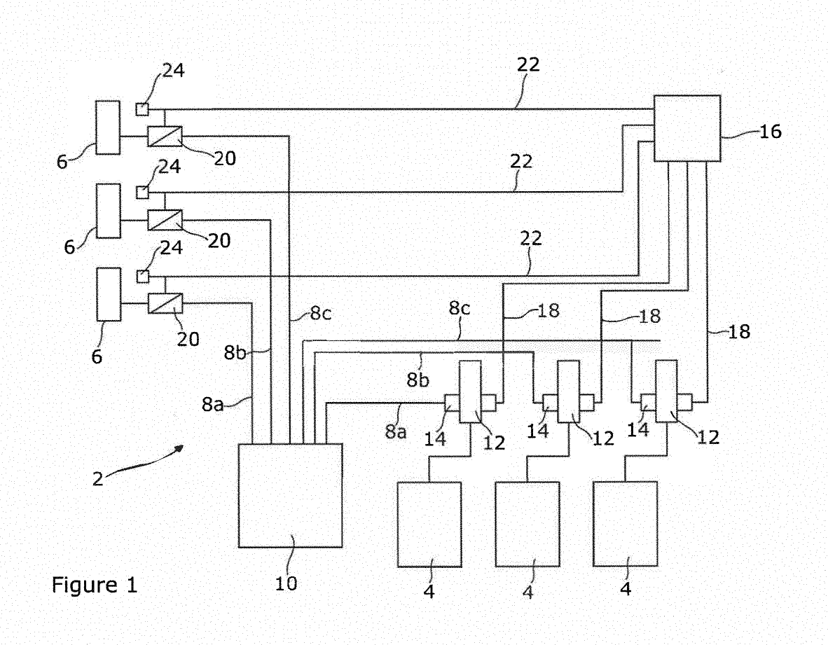

FIG. 1 is a simplified view of dispensing apparatus according to one embodiment of the present invention;

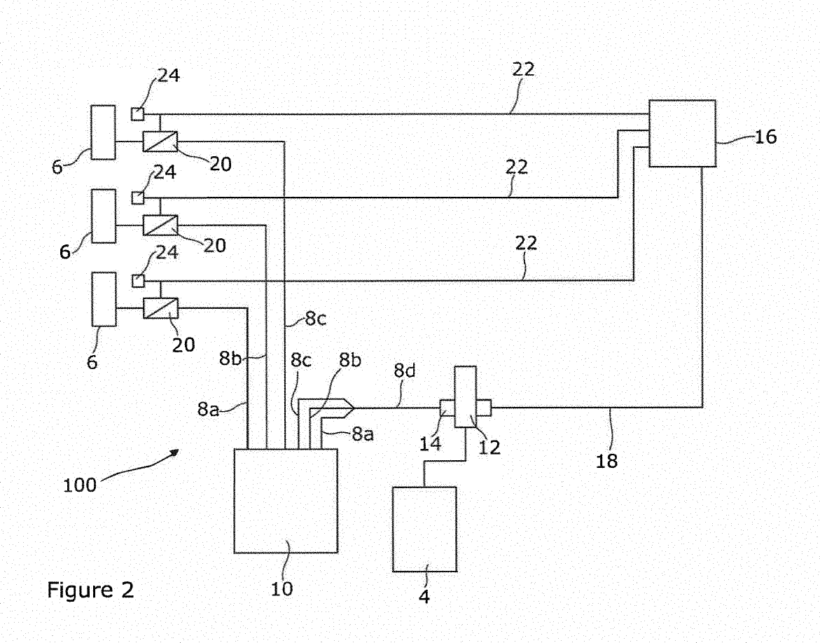

FIG. 2 is a simplified view of dispensing apparatus according to another embodiment of the present invention;

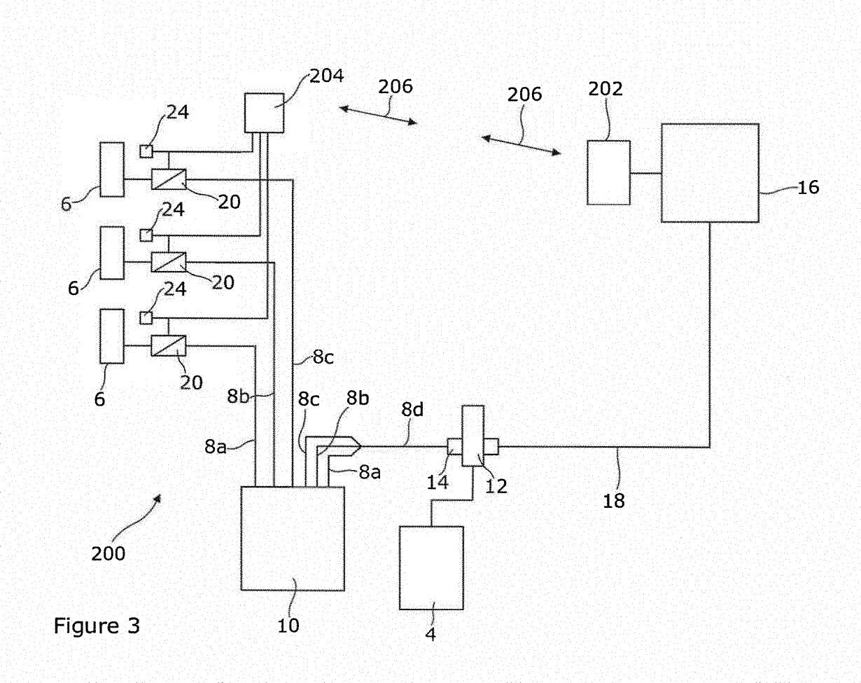

FIG. 3 is a simplified view of dispensing apparatus according to a yet further embodiment of the present invention;

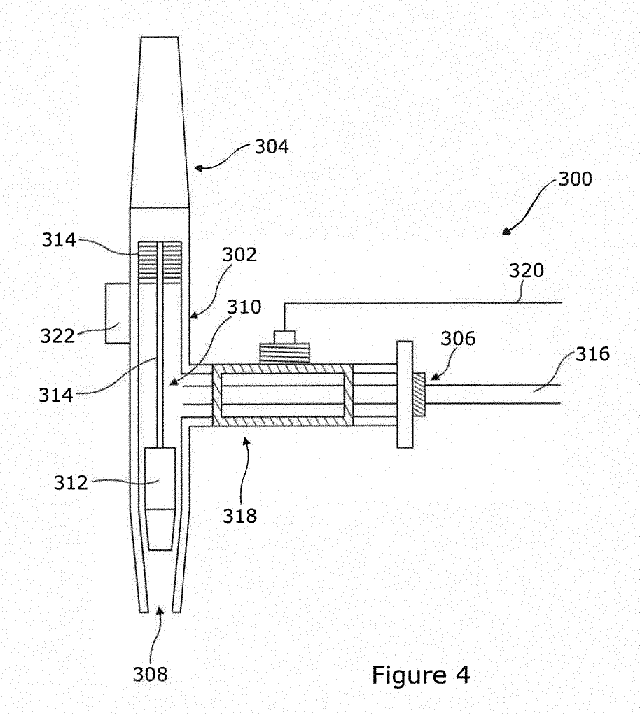

FIG. 4 is a simplified cross sectional view of dispensing outlet means according to an embodiment of the present invention;

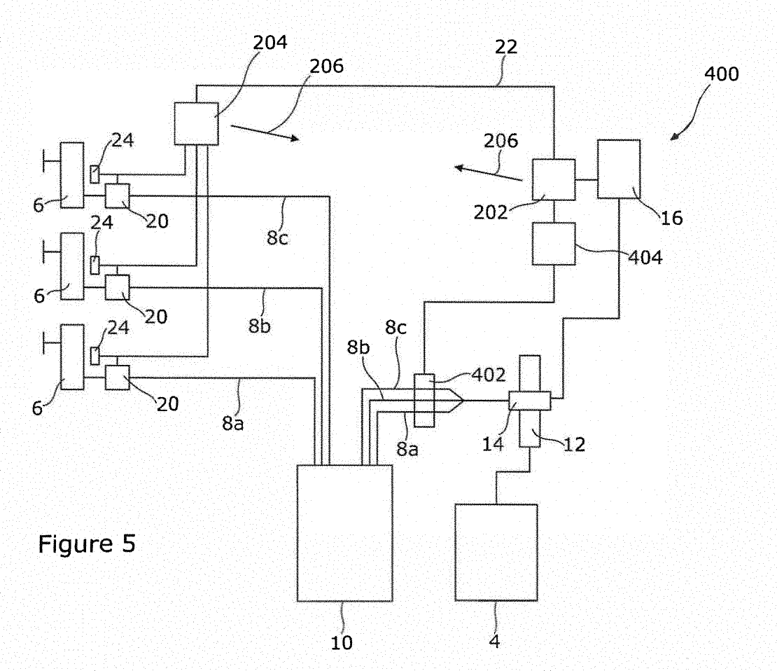

FIG. 5 is a simplified view of dispensing apparatus according to an embodiment of the present invention.

Referring firstly to FIG. 1, there is illustrated dispensing apparatus in the form of beer dispensing apparatus 2 according to an embodiment of the present invention. The apparatus 2 includes a plurality of reservoirs in the form of beer kegs 4 for the containment of the beer, a plurality of dispensing outlet means in the form of free flow beer taps 6 located remotely from the beer kegs 4, and beer flow lines or conduits 8a-8c located between the beer kegs 4 and the beer taps 6 for allowing beer to flow from the beer kegs 4 to the beer taps 6 in use. Each beer tap 6 is movable from an open position, wherein beer can be dispensed from an outlet aperture in the same, to a closed position, wherein beer is prevented from being dispensed from the outlet aperture.

A cooler 10 is provided through which each beer flow line 8a-8c flows in order to cool the beer contained in the flow lines to a required temperature.

In accordance with the present invention detection means in the form of electronic fob detectors 12 are associated with each beer keg 4 to detect when the keg is empty or when there is insufficient beer contained in the keg 4 to dispense. In the illustration, each fob detector 12 includes a chamber through which beer from the keg flows before entering the flow line 8a-8c in use. The chamber includes a float that is located above a side outlet 14 of the chamber when there is beer contained in the keg. As the beer is dispensed from the side outlet 14 (or a bottom outlet (not shown)) and the keg becomes empty, the float becomes lower in the chamber and shuts off the side outlet 14 and actuates a reed switch or continuity connection contained in a base of the chamber. Actuation of the reed switch or continuity connection sends a data signal to a control unit 16 via a communication line 18 provided between each fob detector 12 and the control unit 16 to signal whether a particular keg 4 is empty.

Micro-processing means provided in the control unit 16 processes the data signal from the fob detectors 12 and signals to a solenoid valve 20 provided in the flow line 8a-8c in association with each beer tap 6 via communication lines 22. The solenoid valve is normally in an open position wherein it allows beer to flow through the same to beer tap 6. When the solenoid valve 20 receives a data signal from the control unit 16 that a keg 4 is empty, it moves the solenoid valve 20 associated with that particular beer flow line 8a-8c from the open position to a closed position. With the solenoid valve 20 in a closed position, this closes the beer flow line 8a-8c irrespective of whether the beer tap 6 is an open or closed position. This prevents the beer flow lines 8a-8c from being depressurised when an associated keg 4 becomes empty, thereby preventing fob being formed in the beer lines 8a-8c.

Indication means in the form of a visual light 24 is associated with each beer tap 6. Each light 24 is in communication with the control unit 16 via the communication lines 22. In one example, each light 24 can be lit green when the solenoid valve 20 is in an open position to provide a visual indication to a bar worker that the beer flow line is in an operable position and there is beer contained in keg 4. Once the solenoid valve 20 has been moved to a closed position, the light 24 can be lit red to provide a visual indication to the bar worker that the beer flow line has been closed and a keg 4 needs to be changed.

A bar worker can replace the empty keg 4 with a full keg. For example, the bar worker typically bleeds the fob detection chamber, this is turn raises the float inside the detection chamber, releasing the electrical contact of the float with the reed switch, thereby signalling to the control unit that the keg is now full. The control unit signals to the solenoid valve associated with the particular keg that the keg is full, thereby moving the solenoid valve from the closed position to an open position. With the solenoid valve open, the tap 6 can then be moved from a closed position to an open position to allow beer to once again dispensed from tap 6.

The control unit can detect which data signal has been emitted or generated from which fob detector, thereby allowing the corresponding beer tap in the same beer line as the keg that needs to be replaced to be moved from the open position to the closed position in use.

It will be appreciated that the apparatus could be provided with any number of kegs and/or any number of beer taps as required.

In FIG. 2, beer dispensing apparatus 100 is shown wherein three beer dispensing taps 6 are provided in fluid flow communication with a single beer reservoir or keg 4. Once the keg 4 becomes empty, the fob detector 12 associated with keg 4 communicates this to the control unit 16, which in turn signals to all three solenoid valves 20 associated with the beer taps 6 to move from an open position to a closed position. The visual indication lights 24 can be used to signal to a bar worker that the keg 4 needs to be changed. The flow lines 8a-8c are combined into a single flow line 8d between the cooler 10 and the keg 4.

Although FIGS. 1 and 2 illustrate the present invention including a wired or hard wired system, the communication lines 18 and/or 22 could represent wireless communication lines or include wireless communication if required. This has the advantage that the present invention can be set up in any building, environment, outside and/or the like. Suitable transmitter, receiver and/or transceiver devices can be provided on each component that is to communicate with the control unit 16 in use.

Referring to FIG. 3, wireless dispensing apparatus 200 is illustrated. This apparatus works in a similar manner to the apparatus described above but the control unit 16 communicates wirelessly with the solenoid valves 20 via a transceiver device 202 provided in or associated with control unit 16. More particularly, transceiver device 202 communicates wirelessly with a transceiver device 204 provided with or associated with the three taps 6, the solenoid valves 20 and the indication lights 24, as shown by arrows 206. Once the keg 4 becomes empty, the fob detector 12 associated with keg 4 communicates this to the control unit 16, which in turn signals to all three solenoid valves 20 via the WIFI connection 206 between the two transceivers 202, 204 to move the solenoid valves 20 associated with each beer tap 6 from an open position to a closed position. A signal is also transmitted to the indicator lights to change the light condition and visually indicate that the keg 4 is empty.

The control unit 16 could also be used to communicate with the taps 6 directly or via transceiver 204 to control whether the taps are in the open or closed positions and/or with cooler 10 to control the temperature of the beer in the flow lines 8a-8d and/or the like.

The solenoid valve 20 can be of a free flow type wherein any volume of beer can be dispensed through the same. Alternatively, one or more, or all, of the solenoid valves 20 can be of a metered flow type wherein a pre-determined volume of beer is dispensed through the same and/or the volume of beer being dispensed through the valve can be measured.

The control unit 16 can have user actuation means associated with the same to allow a user to operate the solenoid valve 20, the tap 6, the cooler 10 and/or the fob detector 12 irrespective and/or independently to any other component of the apparatus. For example, a user can move the solenoid valve 20 from the open position to the closed position if they wish to clean the apparatus, irrespective of whether the keg 4 is full or not. This can be performed, for example, by actuating a cleaning over-ride switch on the control unit 16. Once the apparatus has been cleaned, the user can then re-open the solenoid valve to allow normal operation of the dispensing apparatus.

Referring to FIG. 4, there is illustrated dispensing outlet means in the form of a dispensing font or beer tap 300 according to an embodiment of the present invention. The beer tap 300 includes a housing 302 having a tap handle 304, an inlet aperture 306 and an outlet aperture 308. A channel 310 is defined through housing 302 between the inlet aperture 306 and the outlet aperture 308 through which one or more items, such as for example beer, can flow in use. A plunger element 312 is movably connected to tap handle 304 via connection means 314, such that actuation of the tap handle 304 can move the plunger 312 between an open position, wherein the plunger element 312 is moved clear of outlet aperture 308 and beer contained within channel 310 can flow out of said outlet aperture 308, and a closed position, wherein the plunger element 312 closes outlet aperture 308 and beer contained within channel 310 is prevented from flowing out of outlet aperture 308.

The tap handle 304 in this example is manually actuated by a user, but it will be appreciated that the tap handle 304 could be electrically operated if required.

Resilient biasing means, such as for example a spring 314 can be associated with the connection means 314 to resiliently bias the plunger element 312 and the tap handle to a closed position. As such, when a user releases their grip on tap handle 304 in use during opening of the outlet aperture 308, the tap handle 304 and plunger element 312 automatically return to a closed position.

A feed line 316 can be connected to inlet aperture 306 to allow beer to flow from a reservoir into channel 310 of housing 302. The feed line 316 can be connected via any suitable connection means.

In accordance with one aspect of the present invention, valve means in the form of a solenoid valve 318 is provided in housing 302 between inlet aperture 306 and outlet aperture 308 (and preferably upstream of plunger element 312). Thus, in contrast with the embodiments shown in FIGS. 1-3 wherein the solenoid valves are provided in the flow line 8a-8c upstream of beer tap 6, the solenoid valve 318 in this example is provided as an integral part of tap 300. The solenoid valve 318 allows the tap 300 to be remotely controlled in a similar manner to that described in the earlier embodiments.

An electrical cable 320 can be connected to solenoid valve 318 to allow one or more control signals from control unit to be sent directly or indirectly to move the valve 318 between the open and closed positions. Alternatively, the solenoid valve 318 can be controlled via wireless means.

An indicator light 322 can be provided on tap 300 to indicate to a user whether the solenoid valve 318 is in an open or closed position as previously described. However, the indicator light 322 could be provided separate to tap 300 if required.

In one example, the tap handle 304 can be pivotably movable between the open and closed positions.

Referring to FIG. 5, there is illustrated a further embodiment of dispensing apparatus 400 according to the present invention. This apparatus is capable of both wireless communication and wired communication. The two forms of communication can take place simultaneously to each other or independently of and/or separately of each other. A user can also select which form of communication is used at any particular time. This makes this embodiment of the present invention very flexible in terms of how it can be used. The same reference numerals have been used to describe the same features and components as mentioned in earlier embodiments.

Multiple dispensing taps 6 are provided and these are all connected with a central WIFI transceiver unit 204. This WIFI transceiver unit 204 allows wireless communication with the central control unit 16 via WIFI transceiver unit 202, and also allows communication with the control unit 16 via wired connection 16. The provision of two possible communication pathways provides a back-up pathway in the event one of the pathways cannot work, such as if there is a loss of WIFI, if there is damage to the wired connection and/or the like. The single transceiver unit 204 allows control of all the solenoid valves 20 associated with all the dispensing taps 6. A flow meter reporting unit 402 is associated with the flow lines 8a-8c that measures the flow or liquid in each line 8a-8c. The flow meter reporting unit 402 is provided between the cooler 10 and the keg 4. The unit 402 communicates with a flow meter receiving unit 404, that in turn communicates with the control unit 400 via the transceiver unit 202 and that can signal with an information cloud to report on system controls and liquid volumes. The flow receiving unit 404 is the data hub control unit for receiving data from the flow meter. This sends one or more signals to the internet cloud which a customer can log on to their account and see the flow readings on liquid volumes that have passed through their system. It will also provide data relating to the temperature of the liquid, the rate of flow of the liquid and/or the like.

What is claimed is:

1. Dispensing apparatus for dispensing one or more items therefrom in use, said apparatus including at least one reservoir for containment of the one or more items to be dispensed, dispensing outlet means for dispensing the one or more items from said apparatus, and at least one flow conduit or flow line located between the at least one reservoir and the dispensing outlet means, and wherein valve means are provided with or associated with said dispensing outlet means to control dispensing of the one or more items from said dispensing outlet means in use, said valve means movable between an open position, wherein the one or more items can be dispensed from the dispensing outlet means, and a closed position, wherein the one or more items are prevented from being dispensed from said dispensing outlet means, characterised in that the apparatus includes multiple dispensing outlet means, and a control unit is provided and is arranged to communicate with and/or control at least two, or all, of said multiple dispensing outlet means.

2. Dispensing apparatus according to claim 1 wherein the control unit controls and/or communicates with the dispensing outlet means via the valve means provided on or associated with the or each dispensing outlet means and/or via a central valve control unit that communicates with all the valve means.

3. Dispensing apparatus according to claim 1 wherein the apparatus includes detection means for detecting when the reservoir contains an insufficiency of said one or more items to be dispensed therefrom, the apparatus arranged such that on detection of insufficient items to be dispensed by the detection means, this is communicated to the control unit which is arranged to signal to the valve means to move the same from the open position to the closed position.

4. Dispensing apparatus according to claim 1, wherein the control unit communicates with the dispensing outlet means, the valve means and/or the detection means via wired and/or wireless means.

5. Dispensing apparatus according to claim 4 wherein the dispensing outlet means, the control unit, the valve means and/or the detection means includes one or more transmitter means, receiver means and/or transceiver means for transmitting and/or receiving one or more data signals in use.

6. Dispensing apparatus according to claim 1, wherein the control unit is located remotely from the valve means, the dispensing outlet means, the at least one reservoir and/or the detection means.

7. Dispensing apparatus according to claim 1 wherein the control unit includes any or any combination of micro-processing means, software, memory means, user actuation means or display means.

8. Dispensing apparatus according to claim 3 wherein the detection means includes any mechanism which allows detection of the at least one reservoir being empty and/or having insufficient items for dispensing, weight detection means, ultrasonic level detection means, sonic level detection means, fob detection means, one or more reed switches, and/or pressure detection means.

9. Dispensing apparatus according to claim 1 wherein the valve means is movable between open and closed positions independently of actuation of the dispensing outlet means.

10. Dispensing apparatus according to claim 1 wherein the valve means is any or any combination of being electronically controlled, including one or more solenoid valves, is normally in an open position unless the at least one reservoir means has insufficient items to be dispensed, requires no or a reduced power supply to maintain the valve means in an open position in use, is a free flow type, or is a metered flow type.

11. Dispensing apparatus according to claim 1 wherein the dispensing outlet means is any or any combination of a manually actuated dispensing outlet means, and electronically actuated dispensing outlet means, a tap or a font dispenser.

12. Dispensing apparatus according to claim 1, wherein power supply means are provided for supplying electrical power to the control unit, the dispensing outlet means, the valve means and/or the detection means in use.

13. Dispensing apparatus according to claim 1, wherein indication means are provided to allow the status of the dispensing outlet means, the valve means, the flow conduit and/or flow lines and/or the detection means to be indicated to a user in use.

14. Dispensing apparatus according to claim 1, wherein one or more heating devices and/or cooling devices are provided for heating and/or cooling one or more parts of the apparatus respectively in use.

15. A method of using dispensing apparatus for dispensing one or more items therefrom in use, said apparatus including at least one reservoir for containment of the one or more items to be dispensed, dispensing outlet means for dispensing the one or more items from said apparatus, and at least one flow conduit or flow line located between the at least one reservoir and the dispensing outlet means, and wherein valve means are provided with or associated with said dispensing outlet means to control dispensing of the one or more items from said dispensing outlet means in use, said valve means movable between an open position, wherein the one or more items can be dispensed from the dispensing outlet means, and a closed position, wherein the one or more items are prevented from being dispensed from said dispensing outlet means, said method including the steps of dispensing the one or more items from the apparatus via moving the valve means from the closed position to the open position, moving the dispensing outlet means from a closed position to an open position, moving the items from the at least one reservoir to the dispensing outlet means via the at least one flow conduit or flow line, and characterised in that the apparatus includes multiple dispensing outlet means, and a control unit is provided and is arranged to communicate with and/or control at least two, or all, of said multiple dispensing outlet means.
